(19) United States
(12) Patent Application Publication
(10) Pub. No.: US 2014/0237952 A1
(43) Pub. Date: Aug. 28, 2014

(54) METHOD AND APPARATUS FOR OPENING OF CONTAINERS

(71) Applicant: Lance Fesler, Albuquerque, NM (US)

(72) Inventor: Lance Fesler, Albuquerque, NM (US)

(21) Appl. No.: 13/780,124

(22) Filed: Feb. 28, 2013

(51) Int. Cl. B67B 7/12

(52) U.S. Cl. CPC B67B 7/12
USPC 53/492; 81/3.47

(57) ABSTRACT

A method and opener for creating openings in the sidewalls of bead seam containers, such as a pop-top can, to allow air to enter the container when the contents are poured is formed to include a mounting body (140). A seam engagement element (150) sized and shaped to fit the bead seam of a container and a piercing element (152) sufficient to pierce the sidewall of the container are positioned a predetermined distance from each other and in physical association with the mounting body (140) to pierce above the fill level of the container. The bead seam of a container may be inserted into the engagement element (150) creating a fulcrum, then rotated to engage the piercing element (152) to form an opening for air to enter the container when it is poured. These means may be mounted for stationary use (134) or have a handle attached (102) for portability. The portable opener with handle (102) extends a lever body from the mounting body (150) and is operated by placing the engagement element (150) on the bead seam of the container and rotating the handle (106) about the created fulcrum to engage the piercing element (152). These means have been integrated with examples of known bottle openers and tab lifters (20) creating an opener that is capable of lifting pop-top can tabs, opening bottles, and creating openings in the sidewalls of pop-top cans.

### CROSS-REFERENCE TO RELATED APPLICATIONS

Nonprovisional application referencing provisional utility patent application No. 61/604,724 filed on Feb. 29, 2012

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

1. Field

This application relates in general to the opening of containers with a bead seam and, more particularly, a method and apparatus for creating holes in the sidewall of containers with bead seams.

2. Prior Art

The disclosed method and invention relate to a tool for the opening of holes in the sidewall of containers with bead seams, such as pop-top beverage cans, and the incorporation of the invention into other beverage opening tools.

Two of the most popular ways of dispensing individual servings of beverages are in the pop-top beverage cans and capped bottles. A modern pop-top can utilizes a lift tab which is permanently attached to the lid of the can. In lifting the tab, an end of the tab depresses a section of the top of the can which is scored on three sides. The end of the tab presses the scored area inwardly into the can to form an opening in the can. Once the can has been opened the tab is bent back flat and flush against the top of the can allowing the contents to either be poured out or to be removed from the can. While the above described pop-top cans are very convenient, certain individuals have difficulty in opening then and must use some sort of implement assistance in order to lift the tab successfully.

The design of most pop-top cans create only one opening from which the contents of the container are poured from and which allows air to enter the container as it is emptied. The phenomenon is most commonly encountered when attempting to empty a pop-top can very rapidly and is commonly referred to as “glugging”. The “glugging” causes the stream of contents being poured from the pop-top can to be inconsistent making it more difficult to pour the contents into another container or drinking implement. The “glugging” also slows the flow of contents being emptied from the pop-top can and agitates the contents being poured.

The prior art shows different means of adding openings to beverage containers to allow the contents to flow more freely by piercing the top of the container as shown in Kirko U.S. Pat. No. 7,096,759 B2. The methods described in the prior art require a long lever arm to create the force necessary to pierce the thicker metal lid of the can making the device difficult to carry in a pocket or handbag, moreover the prior art is focused on emptying all of the contents of the container and not the ease of use or the flow of the contents from the container.

The prior art also shows methods of piercing the side of the container to allow the contents to flow more freely as shown in Hollander U.S. Pat. No. 4,932,130. The prior art describes a method of piercing a container for venting results in a container that must be emptied once it is pierced and returned to an upright resting position, making it difficult to ventilate the can without spilling some of the contents.

Individual capped bottles of beverages generally are bottled in either a bottle which has a lift off cap, or a screw off cap which theoretically can be removed by twisting off the top of the bottle. It goes without saying that the caps designed to be removed with an opener or other implement cannot be opened without that implement. Many openers have been designed to remove bottle caps as well as include being able to perform other tasks like lifting the tab of a pop-top can, Tricinella U.S. Pat. No. 4,864,898, or additionally denting the sidewall as a tactile indication of the opening of the can as shown in Lawson U.S. Pat. No. 7,827,884 B2. These devices are capable of performing their respective functions adequately yet both lack the ability to ventilate a pop-top can.

A variety of openers suitable for removing the caps on bottles, opening pop-top cans, and marking/indicating the location of the opening on pop-top cans and piercing cans are known and used. The combination bottle cap/pop-top openers and markers have little utility in venting cans to reduce “glugging”, and the openers that pierce the pop-top container are difficult to use and not well suited for being carried in a pocket or handbag and may compromise the containers structure so that it is difficult to drink from the container.

### SUMMARY

From the above it is evident that there exists a need for a new method and opener which can be used for creating holes in the sidewalls of containers with bead seams. Further it is evident that there exists a need to integrate the opener for creating holes in the sidewalls of containers with other container opening methods and devices for example opening, marking, and a locating the opening for pop-top cans, removing caps from capped bottles, removing corks from bottles, and the like. In view of this it is a broad object this invention to provide for a method and apparatus for piercing the sidewall of containers with bead seams.

It is an additional object of this invention to provide for an opener for creating holes in the sidewall of containers with bead seams with elements that are easily integrated with known container opening and beverage key methods and devices, as described above and in the prior art, to create improved beverage keys and openers. Preferably the openings are above the content level of the container to allow the container to remain upright without spilling the contents.

Further it is an object of this invention to provide embodiments that show different manufacturing methods for producing the new opener and integrated openers described above. Preferably the new and integrated openers are formed of unibody construction and of a metallic component, such as stainless steel or other suitable material. A still further object is to provide embodiments that are constructed of a plurality of elements made of a plurality of materials that are assembled in few simple operations.

These and other objects will become evident from the remainder of this specification are achieved in a method and apparatus for creating holes in the sidewalls of bead seam containers and embodiments showing its integration with a plurality of methods and devices of known container openers and beverage keys.

With the foregoing objects outlined and with other objects in view which will appear as the description proceeds, the invention consists in novel features hereinafter described in detail, illustrated in the accompanying drawings, and more particularly pointed out in the appended claims.

### BRIEF DESCRIPTION OF THE DRAWINGS

This invention can be better understood when taken in conjunction with the figures wherein like elements are numbered alike:

FIG. 1a is a perspective view of a stationary sheet metal embodiment of a container opener of the present invention for being mounted to a vertical surface;

FIG. 1b is a perspective view of a portable sheet metal embodiment of a container opener of the present invention;

FIG. 2a is a perspective view of the embodiment in FIG. 1 of the present invention mounted to a vertical surface being used to pierce a typical bead seam container;

FIG. 2b is a side view indicating the section line IV-IV through FIG. 2a;

FIG. 2c is a section view about the line IV-IV showing the piercing means of the embodiment in FIG. 1b of the present invention going through the container sidewall;

FIG. 3a is an exploded isometric view of an improved beverage key of the present invention;

FIG. 3b is a side view of an improved beverage key of the present invention;

FIG. 3c is a sectional view about the line I-I of FIG. 3b;

FIG. 3d is a sectional view about the line II-II of FIG. 3b;

FIG. 4a is a perspective view of the embodiment in FIG. 3a of the present invention being used to ventilate a typical bead seam container;

FIG. 4b a top view indicating the section line III-III through FIG. 4a;

FIG. 4c is a section view about the line III-III showing the piercing means of the embodiment in FIG. 3a of the present invention going through the container can sidewall;

FIG. 5 is a perspective view of the embodiment in FIG. 3 of the present invention showing the use of the tab lifting means of the present invention to lift the tab of a typical bead seam container;

FIG. 6 is a perspective view of the embodiment in FIG. 3 of the present invention showing the use of the opener in removing a bottle cap from a capped bottle;

FIG. 7 is a perspective view of a unibody embodiment of an improved beverage key of the present invention;

FIG. 8 is a perspective view of a flat embodiment of an improved beverage key of the present invention;

FIG. 9a is an exploded perspective view of another embodiment of an improved beverage key of FIG. 3;

FIG. 9b is a side view showing hidden edges of the embodiment in FIG. 9a of the present invention being used to ventilate a typical bead seam container;

FIG. 10 is a perspective view of a church key style embodiment of the present invention;

FIG. 11a is a perspective view of the embodiment in FIG. 10 of the present invention being used to ventilate a typical bead seam container;

FIG. 11b is a perspective view of the embodiment in FIG. 10 of the present invention showing the use of the tab lifting means of the present invention to lift the tab of a typical bead seam container;

FIG. 11c is a perspective view of the embodiment in FIG. 10 of the present invention showing the use of the opener in removing a bottle cap from a capped bottle; and

FIG. 12 is a perspective view of a stamped metal embodiment of an improved beverage key of the present invention with a combined bottle opener and can piercing element; and

FIG. 13a is a perspective view of the embodiment in FIG. 12 of the present invention being used to ventilate a typical bead seam container;

FIG. 13b is a perspective view of the embodiment in FIG. 12 of the present invention showing the use of the tab lifting means of the present invention to lift the tab of a typical bead seam container;

FIG. 13c is a perspective view of the embodiment in FIG. 12 of the present invention showing the use of the opener in removing a bottle cap from a capped bottle; and

FIGS. 14a-f are side views of prior art beverage keys and various openers.

This invention utilizes certain principals and/or concepts as are set forth in the claim appended hereto. Those skilled in the package and utensil arts will realize that these principles and/or concepts are capable of being utilized by embodiments which may differ from the exact embodiment used for illustrative purposes herein. For this reason this invention is not to be construed as being limited solely to the illustrative embodiments, but should only be construed in view of the claims appended hereto.

### DETAILED DESCRIPTION OF THE INVENTION

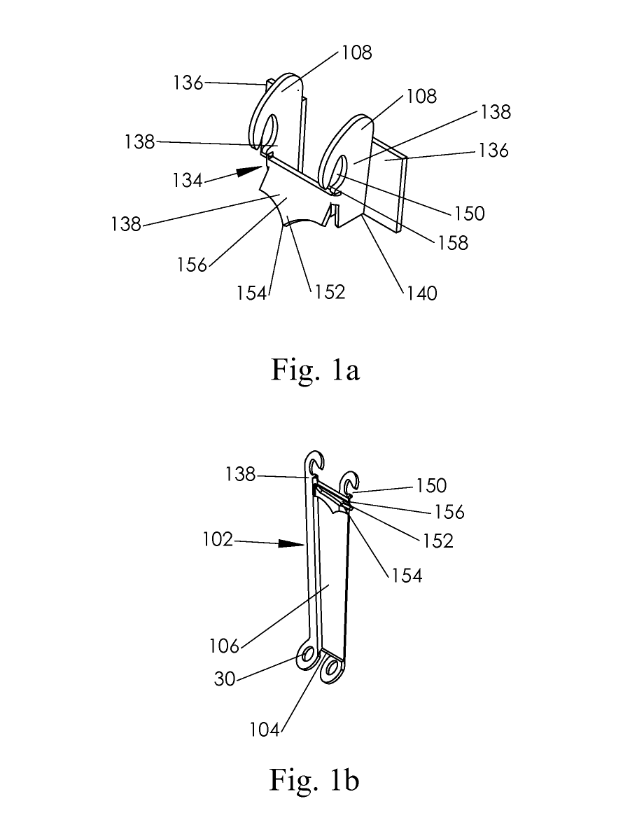

A detailed description of several embodiments of the disclosed invention and methods are presented herein by way of exemplification and not limitation with reference to FIGS. 1-13

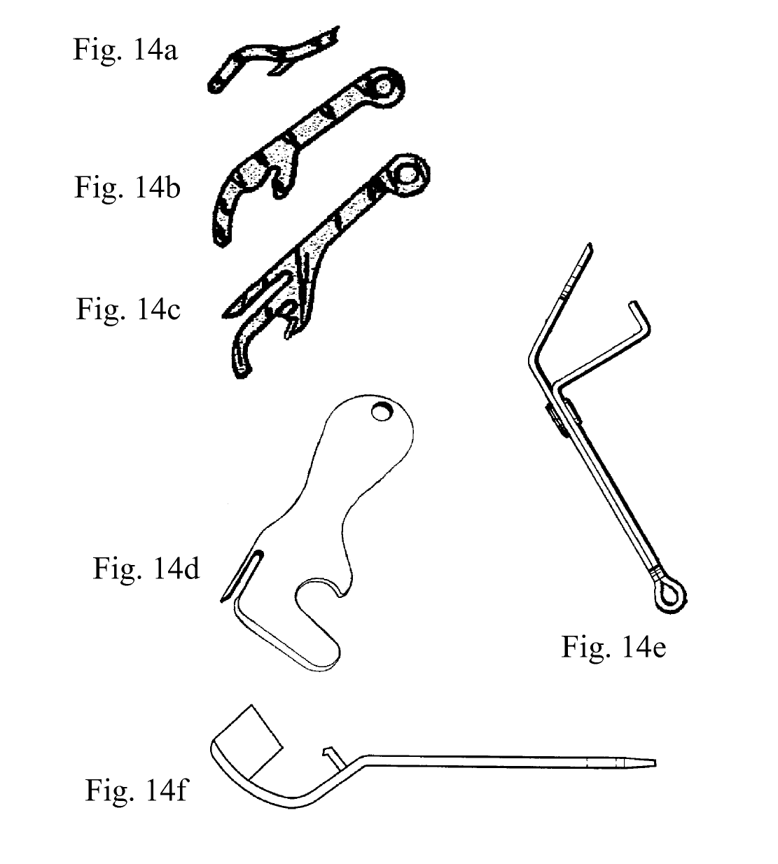

FIG. 14a illustrates one end of a widely used bottle cap opener. This opener is formed on one end of a steel implement which may include a can opener in its other end. A tang is punched from the center of the implement and bent inward from the plane of the implement. This opener features no means for engaging a pop-top can lift tab let alone a reliable means for marking the location of its spout and venting a can. Further, this opener can rust and may not be carried on a key ring or easily in a pocket.

FIG. 14b illustrates a combination bottle opener and pop-top can tab lifter formed of unibody construction that is designed to be used as a key ring. This opener is typically formed of anodized aluminum as such does not rust as does the above opener; however, because it is made from aluminum the edges of the steel bottle caps it is used to remove soon degrade it, rendering it useless as well as potentially dangerous. Further, this opener features no means for a reliable means for marking the location of its spout or venting a can.

FIG. 14c illustrates a combination bottle opener and pop-top can tab lifter not formed of unibody construction that is designed to be used on a key ring. The function of the this opener addresses the wear issues of the device in FIG. 14b by making the bottle cap gripping means out of a different harder material less prone to wear. The device in FIG. 14c does not provide a reliable means for marking the location of the pop-top cans spout or venting a can for easier pouring of the contents.

FIG. 14d illustrates a combination pop-top can opener and opening location marker and bottle opener formed of unibody construction and is capable of opening and marking the opening location of a pop-top can and removing the cap from a capped bottle. This opener does not provide a reliable means venting a can for easier pouring of the contents.

FIG. 14e illustrates an opener for gripping the bottom of a pop-top can while simultaneously allowing piercing of the pop-top can body. This opener only provides a means to ventilate a pop-top can to allow the contents to flow freely. Use of the opener in FIG. 14e does not allow for the contents of the pop-top can to remain in the container when it is upright once it has been used to ventilate the can, making it difficult to use the opener without spilling the contents of the pop-top can.

FIG. 14f illustrates a flip-top can opener for creating an additional hole in the top of the can end to allow the contents to be poured without restriction. Puncturing of the top of the pop-top can may be difficult due to the thickness of the can end. This opener is made in the church key style and may not be carried on a key ring nor easily in a pocket. This opener features reliable means for marking the location of its spout and venting a can.

FIG. 1a shows a stationary embodiment of a container opener 134 of the invention for piercing the sidewall of bead seam containers. The body 140 of the stationary embodiment of the opener 134 may be formed as a unified structure from a suitable material or a plurality of structures and materials. Preferably it is formed of a metal which is strong and stiff and is incapable of bending or breaking during use and capable of piercing the sidewall of a container. Suitable for forming the body 140 would be a metal as, for instance, stainless steel. Many commercial methods for creating the body 140 by being cut from a flat sheet and formed suitably are available, as for instance, stamping.

Further describing FIG. 1a, the body 140 of the opener 134 has a base area 136 which may be integrated with a surface of another object such as a cellular phone case or mounted to the surface of another object by means of adhesive attachment, mechanical attachment or the like to allow the object or surface, such as a wall, refrigerator or the like, to be used to pierce bead seam containers.

Further describing FIG. 1a, extending a predetermined distance from the base 136 is an engagement piercing means 138 wherein a bead seam engagement means 150 and a container sidewall piercing means 152, connected by a sidewall 108, are positioned at a predetermined distance to allow the engagement piercing means 138 to engaging the bead seam of a container to create a fulcrum or pivot thereby engaging a container sidewall piercing means 152 when the container is rotated about the fulcrum or pivot. The engagement means 150 comprising of a generally planar engaging surface 158 surface to engage the bead seam. The piercing means 138 comprising of a generally planar piercing area 156 ending in a piercing element 154, comprising a point or a plurality of points that is sufficiently sharp to pierce the sidewall of the container, is used for piercing the sidewall of a bead seam container.

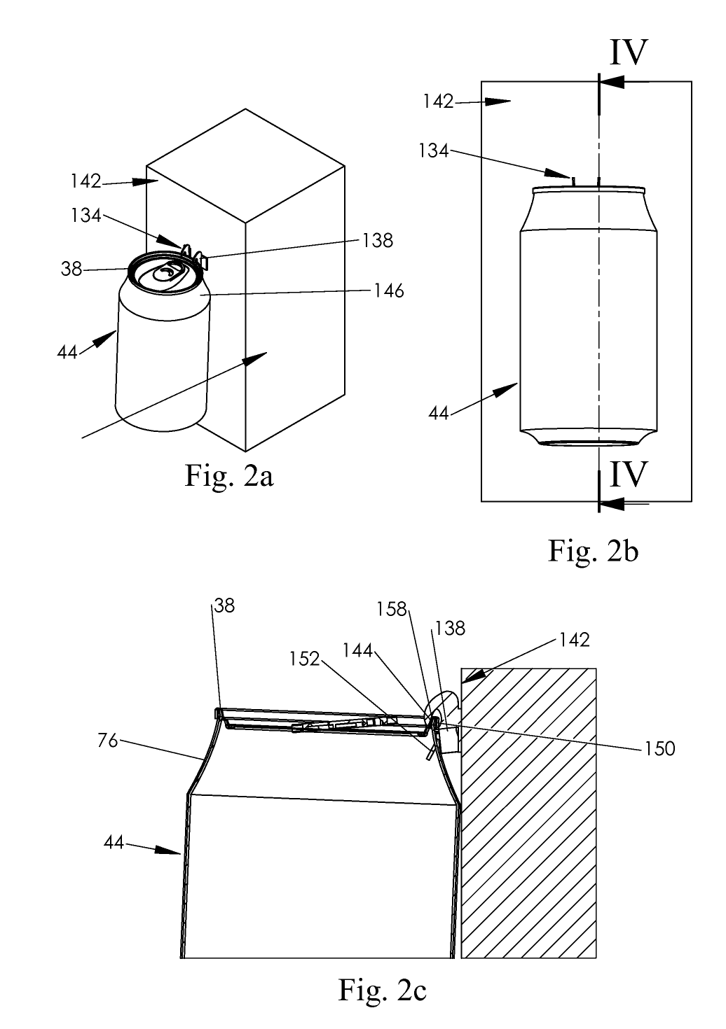

FIG. 2a shows the opener 134 of FIG. 1a attached to a vertical surface 142 in operation to create a hole in a bead seam container 44. The arrow indicates the general direction of rotation of the container 44 to engage the engagement piercing means 138 to pierce the container sidewall 76. FIG. 2b shows the line about which FIG. 2a is sectioned about the line IV-IV and shown in FIG. 2c which shows in detail the bead seam engagement means 150 engaging the engagement surface 158 with the container bead seam 38 thereby creating a fulcrum 144 about which the container 44 is rotated to engage the piercing means 152 to create a hole in the sidewall 76 of the container 44. The container 44 is removed from the opener 134 by reversing the direction of rotation thereby disengaging the seam engagement means 150.

FIG. 1b shows a portable embodiment of a container opener 102 of the invention for piercing the sidewall of bead seam containers. The body 104 of the portable embodiment of the opener 102 may be formed as a unified structure from a suitable material or a plurality of structures and materials. Preferably it is formed of a metal which is strong and stiff and is incapable of bending or breaking during use and capable of piercing the sidewall of a container. Suitable for forming the body 104 would be a metal as, for instance, stainless steel. Many commercial methods for creating the body 104 by being cut from a flat sheet and formed suitably are available, as for instance, stamping.

Further describing FIG. 1b, the body 104 of the opener 102 has a handle area 106 which includes an eye 30 allowing for attachment of the opener to a ring, a chain or the like to assist in maintaining the opener 102 easily accessible or easily stored by the user.

Further describing FIG. 1b, extending a predetermined distance from the handle 106 is an engagement piercing means 138 wherein a bead seam engagement means 150 and a container sidewall piercing means 152 are positioned at a predetermined distance to allow the engagement piercing means 138 to engaging the bead seam of a container to create a fulcrum or pivot thereby engaging a container sidewall piercing means 152 when the handle 106 is rotated about the fulcrum or pivot. The engagement means 150 comprising of a generally planar engaging surface 158 surface to engage the bead seam. The piercing means 138 comprising of a generally planar piercing area 156 ending in a piercing element 154, wherein a point or a plurality of points that is sufficiently sharp to pierce the sidewall of the container, is used for piercing the sidewall of a bead seam container.

The container opener 102 may be sized for use with pop-top containers and integrated with functions of known beverage keys and openers, including lifting the tab of a pop-top can, removing caps from capped bottles, creating indicium for identification and orientation of a pop-top can opening, removing the cork from bottles and the like.

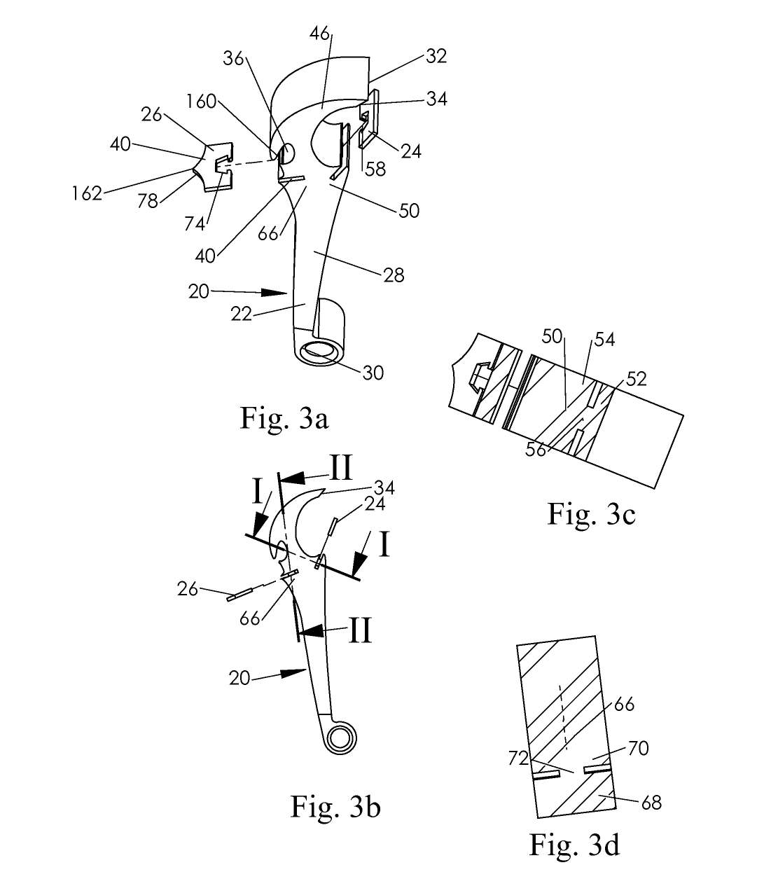

FIG. 3a shows a perspective exploded view of an improved beverage key 20 of the invention capable of lifting the tab of a pop-top can, creating indicium for can identification and opening location orientation of a pop-top can, creating an opening in the sidewall of a pop-top can, and removing the cap from a capped bottle. The beverage key 20 is generally formed in three separate structures of two separate materials. It includes a body 22 an edge gripper plate 24 and a piercing plate 26. In FIG. 3a the edge gripper plate 24 and the piercing plate 26 are shown exploded away from the remainder of the body 22.

Further describing FIG. 3a, the body 22 is formed as a unified structure from a suitable material. Preferably it is formed of a polymeric material which when polymerized is strong and stiff and is incapable of bending or breaking during use. Suitable for forming the body 22 would be a polyamide as, for instance a nylon. This material is improved by incorporating fibers in the material for added strength against flexure. Thus, preferred for forming the body 22 would be a glass fiber filled nylon. Many commercial formulations of such fiber filled polymeric materials are available for use with common molding machines, as for instance, injection molding machines.

Further describing FIG. 3a, the edge gripper plate 24 and piercing plate 26 are preferably formed of a metal. Most useful because of its properties would be stainless steel. By utilizing stainless steel for forming the edge gripper plate 24 and the piercing plate 26, not only will the edge gripper plate 24 and the piercing plate 26 not rust, but both will be essentially impervious to deformation. Many prior bottle openers are formed either of regular steel which tends to rust with use or of aluminum which is abraded by the edges of the bottle caps and thus limits the lifetime of such an aluminum bottle opener.

Still further describing FIG. 3a, the body 22 of the beverage key 20 has a handle portion 28 which includes an eye 30 allowing for attachment of the beverage key to a key ring, a chain or the like to assist in maintaining the beverage key 20 easily accessible to the user.

Still further describing FIG. 3a, extending from the handle 28 is a lift and fulcrum means 46. The lift and fulcrum means 46 includes a tab lifting means 32 including a wedge surface 34 on its end capable of being slid underneath the tab of a pop-top can. Extending from the same handle 28 on the opposite side of the wedge surface 34 is a bead seam engagement means 36 and a pop-top can piercing means 40, including a sidewall piercing plate foundation area 66 and a piercing plate 26, that are positioned at a predetermined distance to allow the engagement means 36 to engaging the bead seam of a container to create a fulcrum or pivot thereby engaging the can piercing means 40 when the handle 28 is rotated about the fulcrum or pivot. The engagement means 36 comprising of a generally planar engaging surface 160 to engage the bead seam. The piercing plate 26 comprising of a generally planar piercing area 78 ending in a piercing element 162, wherein a point or a plurality of points that is sufficiently sharp to pierce the sidewall of the container, is used for piercing the sidewall pop-top can thereby ventilating the can.

Further describing FIG. 3a, for ventilating cans, in combination with the seam engagement means 36, the body 22 of the beverage key includes a piercing plate foundation area 66. The foundation area 66 is formed as a projection of the body 22 which extends away from the body 22 which extends away from the elongated axis of the body 22. FIG. 3b shows the line II-II about which the beverage key 20 is sectioned through the piercing plate foundation area 66 in FIG. 3d. FIG. 3d shows the piercing plate foundation area 66 including a lower lip 68 which is spaced away from an upper lip 70 with a central web 72 located and extending between the lips 66 and 68.

Further describing FIG. 3a, for opening bottles, in combination with the fulcrum means 46, the body 22 of the beverage key 20 includes an edge gripping plate foundation area 50. The foundation area 50 is formed as a projection of the body 22 which extends away from the body 22, on the opposite side as the piercing plate foundation area 66, which extends away from the elongated axis of the body 22. The area 50 shown in FIG. 3c, a section view about line I-I of FIG. 3b, includes a bottom lip 52 which is spaced away from a top lip 54 with a central web 56 located and extending between the lips 52 and 54.

Still further describing FIG. 3a, the edge gripping plate 24 is formed with a cutout 58 which is sized and shaped to be slightly undersized with respect to the thickness of the central web 56. The thickness of the edge gripping plate 24 is essentially the same as that between the top and bottom lips 52 and 54. The edge gripping plate 24 can be inserted over the central web 56 and forced onto the central web 56. Because the body 22 is made of a polymeric material there is a certain cold flow of this material allowing for positioning and locking of the cutout 58 on the edge gripping plate 24 over the central web 56 to permanently adhere the edge gripping plate 24 to the body 22.

Still further describing FIG. 3a, the piercing plate 26 is formed with a cutout 74 which is sized and shaped to be slightly undersized with respect to the thickness of the central web 72. The thickness of the piercing plate 26 is essentially the same as that between the top and bottom lips 66 and 68. The piercing point 40 needs only to be sufficiently sharp and shaped to be able to pierce the sidewall 76 of a pop-top can and to not easily cause injury to ones body, clothes or the like. The piercing plate 26 can be inserted over the central web 72 and forced onto the central web 72. Because the body 22 is made of a polymeric material there is a certain cold flow of this material allowing for positioning and locking of the cutout 74 on the piercing plate 26 over the central web 72 to permanently adhere the piercing plate 26 to the body 22.

The embodiment of the invention shown in FIG. 3a is an improved beverage key that is small in size so it may conveniently be carried in a pocket or purse. Further, said embodiment is able to easily lift the tab and ventilate pop-top cans providing indicium for can identification and opening location orientation of a pop-top can as well as opening capped bottles making it a more convenient and “complete” beverage tool.

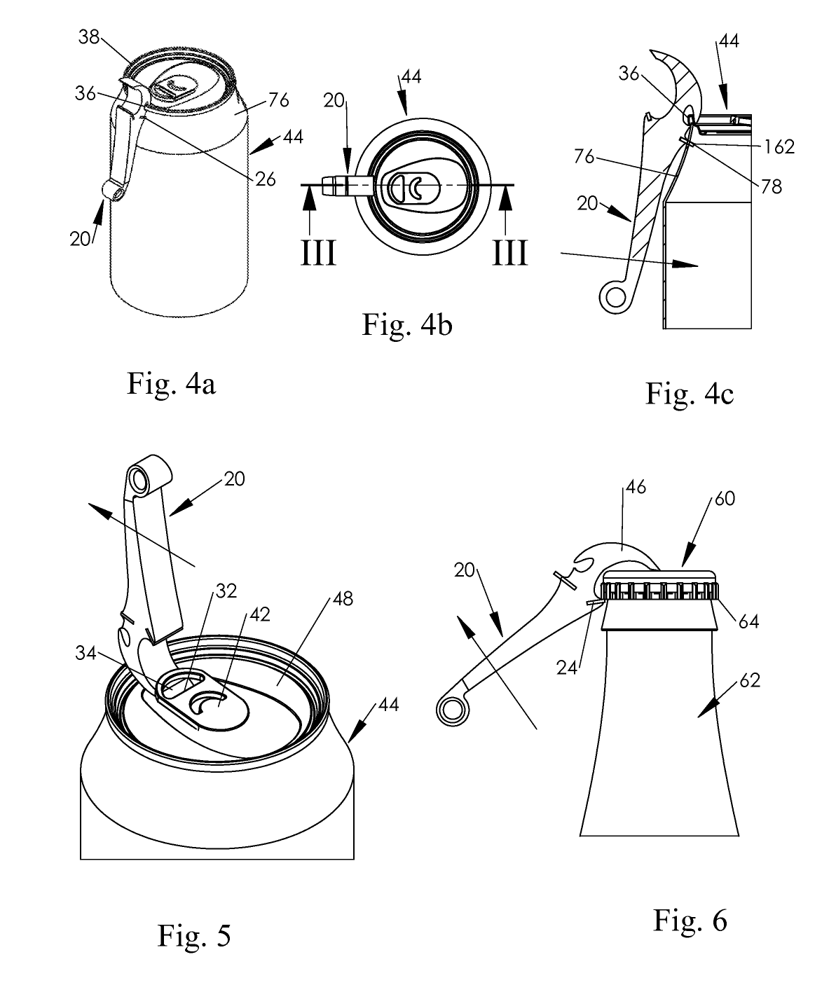

In FIG. 4a the beverage key 20 of the invention is being utilized to ventilate a pop-top can 44. To do so the bead seam engagement means 36 is placed over the pop-top can end bead seam 38 and the piercing element 162 (not shown) of the piercing plate 26 is in contact or in close proximity to the pop-top can sidewall 76. Rotation of the beverage key in a normal manor forces the piercing element 162 (not shown) through the sidewall 76 of the pop-top can 44 and enlarges the initial opening with continued rotation thereby creating an opening to ventilate the pop-top can 44. FIG. 4b shows the section line III-III for the opener 20 and the container 44. FIG. 4c, a section view of about the line III-III of FIG. 4b, shows the piercing element 162 and the piercing area 78 of the beverage key 20 through the sidewall 76 after the beverage key has been rotated in the general direction of the arrow thereby ventilating the pop-top can 44.

In FIG. 5 a beverage key 20 of the invention is being utilized to open a pop-top can 44. To open the can the lift means 32 is slid underneath the lift tab 42 of the can 44. The wedge surface 34 assists in initially raising the lift tab 42 from the top surface of the can end 48. Once the lift means 32 is in position under the lift tab 42 the beverage key may be rotated to press against the can end 48 in the general direction indicated by the arrow lifting the lift tab 42 and assisting in opening the pop-top can 44. If the beverage key does not fully open the can 44 the lift tab 42 will be in a position that is easily operated by the user. Also, because the lift tab 42 is already lifted the user does not have to initially pry the lift tab 42 from the surface of the can end 48 the fingernails of the user are not in jeopardy of being broken and because the opening of the can 44 has already been initiated the force required to fully lift the lift tab 42 is greatly reduced allowing children of other individuals with weak or diseased hands to effectively open the pop-top can 44 with ease.

In FIG. 6 the beverage key 20 of the invention is being utilized to remove a cap 60 from a bottle 62. To do so the edge gripping plate 24 is located under the lip 64 of the cap 60 and the end of the fulcrum means 46 is positioned on top of the cap 60. Rotation of the beverage key in a normal manner in the general direction indicated by the arrow lifts the cap 60 from the bottle 62.

Still further describing FIG. 3a, as so formed and constructed the beverage key of the invention is utilitarian for capable of lifting the tab of a pop-top can, creating indicium for can identification and opening location orientation of a pop-top can, creating an opening in the sidewall of a pop-top can, and removing the cap from a capped bottle. Because the beverage key is formed as a multi-piece opener utilizing separate edge gripping plate 24 and piercing plate 26 from the body 22, advantages can be taken of both metallic properties for the edge gripping plate 24 and piercing plate 26 for resisting wear in gripping a lip 64 of a cap 60 or piercing a sidewall 76 and with polymeric properties of the materials of the body 22 which are strong, sanitary, and lightweight.

The improved beverage key 20 is small in size it can conveniently be carried in a pocket or purse. Further, the invention is able to easily open and ventilate pop-top cans providing indicium for can identification and opening location orientation of a pop-top can as well as opening capped bottles making it a more convenient and “complete” beverage opening tool.

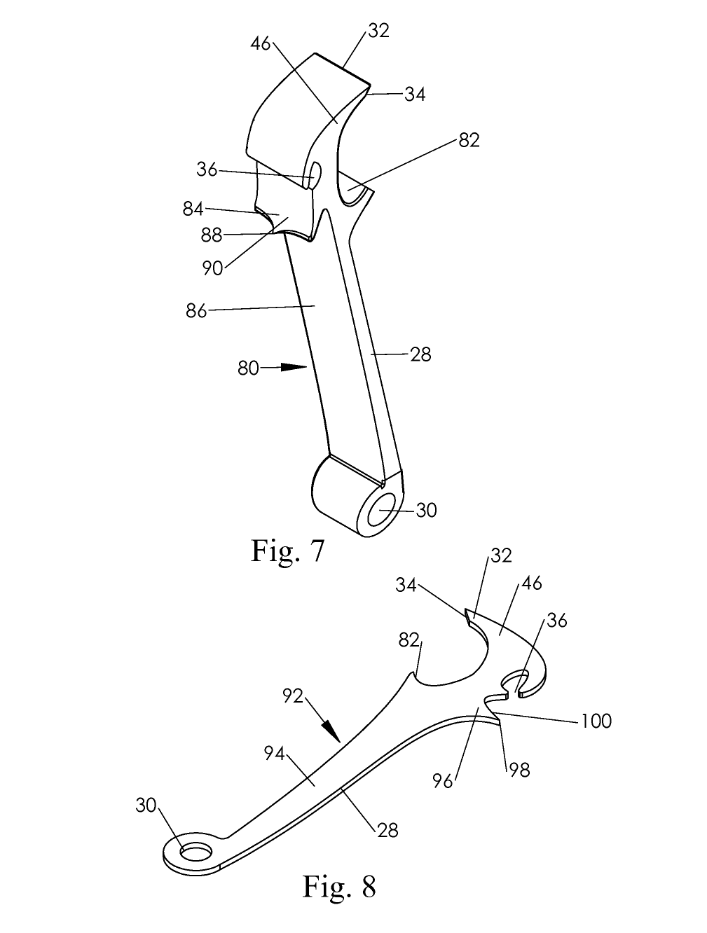

FIG. 7 discloses another exemplary embodiment of the beverage key 80 of the invention formed of unibody construction. The body 86 of the unibody embodiment of the beverage key 80 may be formed as a unified structure from a suitable material. Preferably it is formed of a metal which is strong and stiff and is incapable of bending or breaking during use. Suitable for forming the body 86 would be a metal as, for instance stainless steel. Many commercial methods for creating the body 86 are available, as for instance, 3d printing.

Referring now to the embodiment of the invention in more detail, in FIG. 7 the body 86 of the unibody beverage key 80 incorporates the functions of a sidewall piercing means 84 and a bottle cap edge gripping means 82 with the body 86 thereby removing the need for an edge gripping plate 24, a piercing plate 26 or the associated foundation areas 50-56 and 66-72 of the body 22 of the beverage key in FIGS. 3a-d. Referring again to FIG. 7, the unibody beverage key 80 utilizes a bottle cap edge gripping means 82 to remove caps from bottles and a can piercing means 84 with a piercing element 88 and piercing area 90 to ventilate pop-top cans. The embodiment of the beverage key 80, shown in FIG. 7, operates in the same way as the beverage key shown in FIGS. 4-6 to ventilate pop-top cans, lift the tab of pop-top cans, and remove the cap from capped bottles.

The embodiment of the invention shown in FIG. 7 is an improved beverage key that is small in size so it may conveniently be carried in a pocket or purse. Further, said embodiment is able to easily lift the tab and ventilate pop-top cans providing indicium for can identification and opening location orientation of a pop-top can as well as opening capped bottles making it a more convenient and “complete” beverage tool.

FIG. 8 discloses another exemplary embodiment of the beverage key 92 formed of a flat unibody construction. The flat body 94 of the flat unibody embodiment of the beverage key 92 may be formed as a unified structure from a suitable material. Preferably it is formed of a metal which is strong and stiff and is incapable of bending or breaking during use. Suitable for forming the body 94 would be a metal as, for instance stainless steel. Many commercial methods for creating the body 94 by being cut from a flat sheet are available, as for instance, laser cutting.

Referring now to the embodiment of the invention in more detail, in FIG. 8 The body 94 of the flat unibody beverage key 92 utilizes a can piercing means 96 with a piercing element 98 and piercing area 100 to pierce the sidewall of pop-top cans. The embodiment of the beverage key 92, shown in FIG. 8, operates in the same way as the beverage key shown in FIGS. 4-6 to ventilate pop-top cans, lift the tab of pop-top cans, and remove the cap from capped bottles.

The embodiment of the invention shown in FIG. 8 is an improved beverage key that is small in size so it may conveniently be carried in a pocket or purse. Further, said embodiment is able to easily lift the tab and ventilate pop-top cans providing indicium for can identification and opening location orientation of a pop-top can as well as opening capped bottles making it a more convenient and “complete” beverage tool.

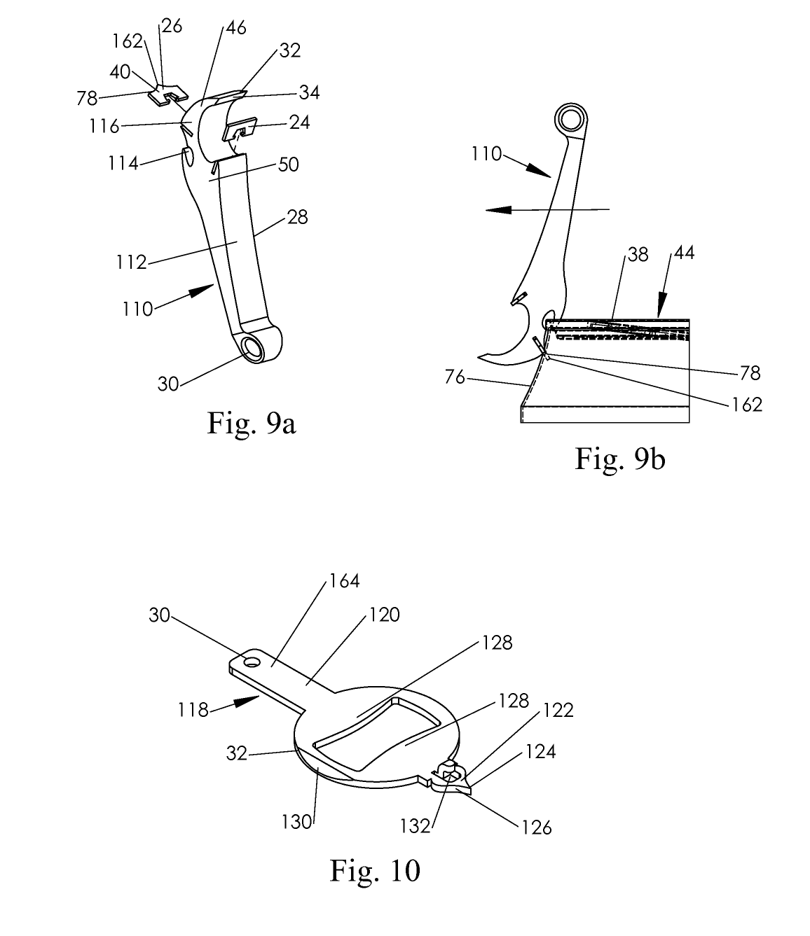

FIG. 9a discloses another exemplary embodiment of the beverage key 110 which is generally formed in three separate pieces, a body 112, a piercing plate 26, and a edge gripping plate 24, of two separate materials in the same way that the beverage key shown in FIGS. 3a-d has been described previously. The bead seam engagement means 114 and the piercing plate foundation 116 of the beverage key 110 have been rotated along the long axis of the opener body 112 with reference to the description of the beverage key shown in FIGS. 3a-d. The beverage key 110 operates in the same way as the beverage key shown in FIGS. 5-6 to lift the tab of pop-top cans and remove the cap from capped bottles.

FIG. 9b shows the orientation and normal operating direction, indicated by the arrow, for the beverage key 110 to ventilate a pop-top can 44. To do so the bead seam engagement means 114 is placed over the pop-top can end bead seam 38 and the piercing element 162 of the piercing plate 26 is in contact or in close proximity to the pop-top can sidewall 76. Rotation of the beverage key in the general direction indicated by the forces the piercing element 162 through the sidewall 76 of the pop-top can 44 and enlarges the initial opening with continued rotation thereby creating an opening to ventilate the pop-top can 44. FIG. 9b shows the piercing element 162 and the piercing area 78 of the beverage key 110 through the sidewall 76 after the beverage key has been rotated in the general direction of the arrow thereby ventilating the pop-top can 44

FIG. 10 discloses another exemplary embodiment of an improved beverage key 118 formed of a church key style unibody construction. The body 120 of the church key style unibody embodiment of the beverage key 118 may be formed as a unified structure from a suitable material. Preferably it is formed of a metal which is strong and stiff and is incapable of bending or breaking during use. Suitable for forming the body 120 would be a metal as, for instance stainless steel. Many commercial methods for creating the body 120 by being cut and formed from a flat sheet are available, as for instance, stamping.

Further describing FIG. 10, the body 120 of the beverage key 118 has a handle portion 164 which includes an eye 30 allowing for attachment of the beverage key 118 to a key ring, a chain or the like to assist in maintain the beverage key 118 easily accessible to the user.

Still further describing FIG. 10, extending from the handle 164 is an edge gripping and fulcrum means 128. The edge gripping and fulcrum means 128 includes a wedge surface 130 on one exterior edge. Extending from the same handle 164 on the opposite side of the edge gripping and fulcrum means 128 is a bead seam engagement means 132 for the bead seam of the pop-top can 38 to fit in to create a fulcrum or pivot to engage the can piercing element 124 wherein a point or a plurality of points that is sufficiently sharp to pierce the sidewall of the container, is used for piercing the sidewall of a bead seam container.

Even further describing FIG. 10, the body 120 of the beverage key is formed of an essentially elongated lever with a edge gripping and fulcrum means 128 with a wedged surface 130 on one side and ending in another elongated structure consisting of the bead seam engagement means 132, cutting surface 126, and the piercing means 122. As such the wedge surface 130 is formed as an elongated smooth surface which is capable of being slid underneath the lift tab of a pop-top can.

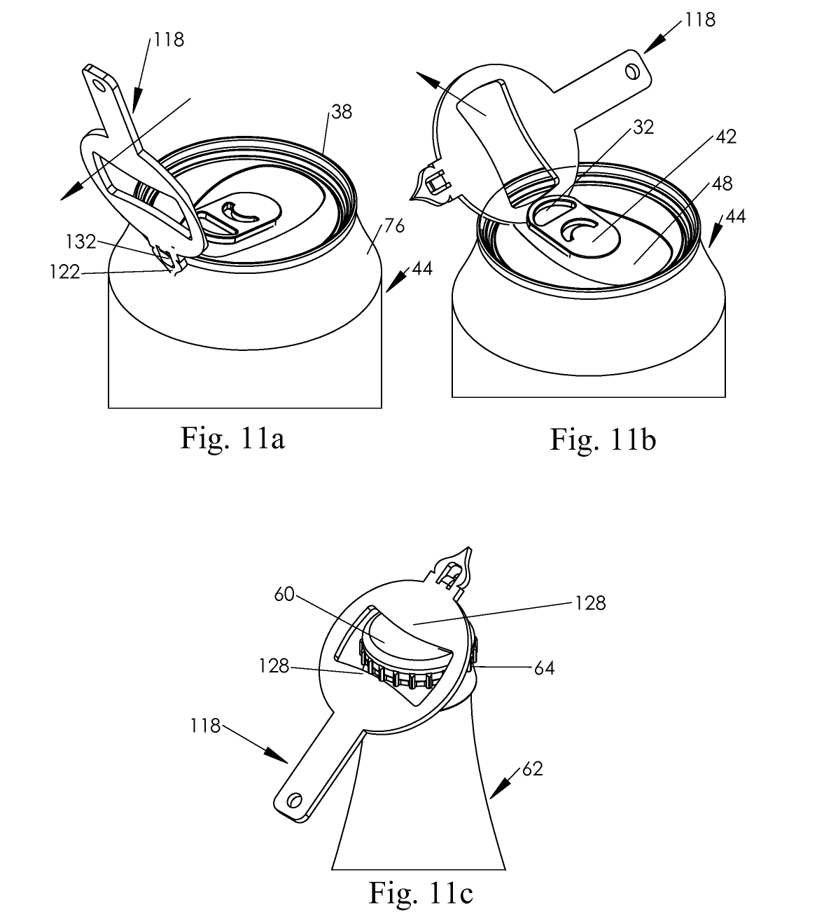

Though the embodiment of the beverage key 118 illustrated in FIG. 10 is shaped very differently than the other embodiments of the beverage key 118 provides means to mark and ventilate pop-top cans, lift pop-top can tabs, and open capped bottles. FIG. 11a illustrates the operation of the beverage key 118, shown in FIG. 10, using the same principals as the opener 110 in FIG. 9b to ventilate cans. To do so the bead seam engagement means 132 is placed over the pop-top can end bead seam 38 and the piercing element 124 (not shown) of the piercing means 122 is in contact or in close proximity to the pop-top can sidewall 76. Rotation of the beverage key in a normal manor, as indicated by the arrow forces the piercing element 124 (not shown) through the sidewall 76 of the pop-top can 44 and enlarges the initial opening with continued rotation thereby creating an opening to ventilate the pop-top can 44.

FIG. 11b illustrates the use of the beverage key 118 of FIG. 10 to lift the tab 42 of a pop-top can 44. To open the can the lift means 32 is slid underneath the lift tab 42 of the can 44. The wedge surface 34 assists in initially raising the lift tab 42 from the top surface of the can end 48. Once the lift means 32 is in position under the lift tab 42 the beverage key may be rotated, in the general direction indicated by the arrow, to press against the can end 48 lifting the lift tab 42 and assisting in opening the pop-top can 44. If the beverage key does not fully open the can 44 the lift tab 42 will be in a position that is easily operated by the user. Also, because the lift tab 42 is already lifted the user does not have to initially pry the lift tab 42 from the surface of the can end 48 the fingernails of the user are not in jeopardy of being broken and because the opening of the can 44 has already been initiated the force required to fully lift the lift tab 42 is greatly reduced allowing children or other individuals with weak or diseased hands to effectively open the pop-top can 44 with ease.

FIG. 11c illustrates the operation of the beverage key 118, shown in FIG. 10, to remove a cap 60 from a capped bottle 62. To do so the edge gripping and fulcrum means 128 is oriented so that one edge is located under the lip 64 of the cap 60 and the other edge of the gripping and fulcrum means 128 is positioned on top of the cap 60. Rotation of the beverage key in a normal manner in the general direction indicated by the arrow lifts the cap 60 from the bottle 62.

The embodiment of the invention shown in FIG. 10 is an improved beverage key that is small in size so it may conveniently be carried in a pocket or purse. Further, said embodiment is able to easily lift the tab and ventilate pop-top cans providing indicium for can identification and opening location orientation of a pop-top can as well as opening capped bottles making it a more convenient and “complete” beverage tool.

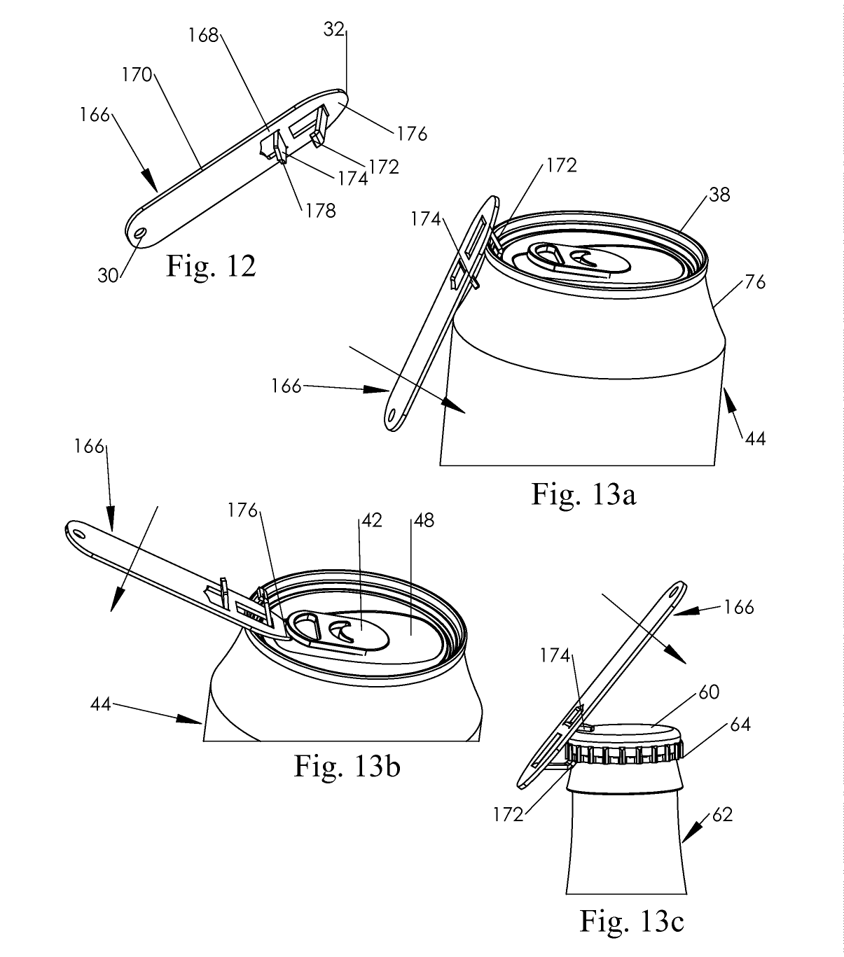

FIG. 12 discloses another embodiment of an improved beverage key 166 formed of a church key style unibody construction. The body 168 of the church key style unibody embodiment of the beverage key 166 may be formed as a unified structure from a suitable material. Preferably it is formed of a metal which is strong and stiff and is incapable of bending or breaking during use. Suitable for forming the body 168 would be a metal as, for instance stainless steel. Many commercial methods for creating the body 168 by being cut and formed from a flat sheet are available, as for instance, stamping.

Further describing FIG. 12, the body 168 of the beverage key 166 has a handle portion 170 which includes an eye 30 allowing for attachment of the beverage key 166 to a key ring, a chain or the like to assist in maintain the beverage key 166 easily accessible to the user.

Still further describing FIG. 12, extending from the handle 164 is a combined cap fulcrum and can piercing element 174. Extending from the same handle 164 on the same side of the combined fulcrum and can piercing element 174 is a combined edge gripping, bead seam fulcrum means, and bead seam engagement means 172 for the bead seam of the pop-top can 38 to fit in to create a fulcrum or pivot to engage the combination cap fulcrum and can piercing means 174. Wherein a point or a plurality of points that is sufficiently sharp to pierce the sidewall of the container, creating a piercing element 178 is used for piercing the sidewall of a bead seam container. The combined gripping, fulcrum and engagement means 172 is also capable of gripping the edge of a bottle cap for removal.

Further describing FIG. 12, the body 168 of the beverage key is formed of an essentially elongated lever with a combined fulcrum and can piercing means 174 continuing to a combined gripping, fulcrum, and engagement means 172 ending in a lifting surface 176. As such the lifting surface 176 is formed as an elongated smooth surface which is capable of being slid underneath the lift tab of a pop-top can.

Though the embodiment of the beverage key 166 illustrated in FIG. 12 is shaped very differently than the other embodiments of the beverage key 166 provides means to mark and ventilate pop-top cans, lift pop-top can tabs, and open capped bottles. FIG. 13a illustrates the operation of the beverage key 166, shown in FIG. 12, using the same principals as the opener 110 in FIG. 9b to ventilate cans. To do so the combination gripping, fulcrum, and engagement means 172 is placed over the pop-top can end bead seam 38 and the piercing element 178 (not shown) of the combination piercing and fulcrum means 174 is in contact or in close proximity to the pop-top can sidewall 76. Rotation of the beverage key in a normal manor, as indicated by the arrow forces the piercing element 178 (not shown) through the sidewall 76 of the pop-top can 44 and enlarges the initial opening with continued rotation thereby creating an opening to ventilate the pop-top can 44.

FIG. 13b illustrates the use of the beverage key 166 of FIG. 12 to lift the tab 42 of a pop-top can 44. To open the can the lift surface 176 is slid underneath the lift tab 42 of the can 44. The lift surface 176 assists in initially raising the lift tab 42 from the top surface of the can end 48. Once the lift surface 176 is in position under the lift tab 42 the beverage key may be rotated, in the general direction indicated by the arrow, to press against the can end 48 lifting the lift tab 42 and assisting in opening the pop-top can 44. If the beverage key does not fully open the can 44 the lift tab 42 will be in a position that is easily operated by the user. Also, because the lift tab 42 is already lifted the user does not have to initially pry the lift tab 42 from the surface of the can end 48 the fingernails of the user are not in jeopardy of being broken and because the opening of the can 44 has already been initiated the force required to fully lift the lift tab 42 is greatly reduced allowing children or other individuals with weak or diseased hands to effectively open the pop-top can 44 with ease.

FIG. 13c illustrates the operation of the beverage key 166, shown in FIG. 12, to remove a cap 60 from a capped bottle 62. To do so the combination gripping, fulcrum, and engagement means 172 is oriented so that one edge is located under the lip 64 of the cap 60 and the piercing and fulcrum means 174 is positioned on top of the cap 60. Rotation of the beverage key in a normal manner in the general direction indicated by the arrow lifts the cap 60 from the bottle 62.

The embodiment of the invention shown in FIG. 12 is an improved beverage key that is small in size so it may conveniently be carried in a pocket or purse. Further, said embodiment is able to easily lift the tab and ventilate pop-top cans providing indicium for can identification and opening location orientation of a pop-top can as well as opening capped bottles making it a more convenient and “complete” beverage tool.

In broad embodiment, the present invention is a method and container opener for creating openings in the sidewalls of containers with bead seams that uses an engagement means to create a fulcrum about which the opener or container may be rotated to engage a piercing means to create said opening. Further the opener may be integrated with elements and means of other known beverage keys, container openers and the like to create beverage keys and container openers capable of piercing the sidewall of a container with a bead seam.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A method for piercing the sidewall of a container with a bead seam comprising of:
providing said container with a bead seam and providing an opener with an elongated body and an engaging device for engaging the bead seam of said container to create a fulcrum and a piercing device for piercing the sidewall of said container;
providing said engaging device and said piercing device are proximal and spaced sufficiently to allow said opener when rotated about said fulcrum to pierce the sidewall of said container;
rotating said opener about said fulcrum in a manner that engages the piercing device to pierce the sidewall of said container creating a ventilation opening, reversing the rotation of said beverage key orients the engagement device to be disengaged;
providing said container has a pouring opening already incorporated the location of said ventilation opening is approximately located on the opposite side of the container as said pouring opening; and
providing said container does not incorporate any means for pouring a plurality of openings may be created in the sidewall of said for pouring or ventilating;
providing the level of the contents of said container can are below said opening said container may remain upright without spilling the contents;
whereby said container has said opening to allow air to enter said container from a separate opening than the one used for pouring.

2. The method of piercing the sidewall of a container of claim 1, providing said engaging device and said piercing device are spaced sufficiently to allow said engaging device to engage the edge of a bottle cap;
whereby said piercing means creates a fulcrum to remove said bottle cap when rotated about said fulcrum.

3. A container opener for creating openings on the sidewall of containers with bead seams comprising:
a base formed as a unitary elongated planar body of rigid material of sufficient size to allow it to be mounted on a planar surface and having a general upper surface and a general lower surface;
an engagement puncturing means located on the upper surface and projecting a predetermined distance from the base is comprised of a container piercing means and a bead seam engagement means, said piercing means and said bead seam engagement means are in physical association and are formed as an extension of said base, and are separated by a predetermined distance to allow said engagement means and piercing means to engage and pierce said container;
said bead seam engagement means for engagement of a bead seam of a container being configured to engage a portion of said bead seam of said container creating a fulcrum or pivot such that when said container is pivoted about said fulcrum or pivot, the intersection of said container piercing means with said sidewall of said container in a manner that creates an opening in said sidewall; and
said container piercing means for piercing said sidewall, formed of material suitable for piercing the sidewall of said container, is formed generally as a wedge comprising of two planar surfaces ending in a piercing element, wherein a point or a plurality of points sufficiently shaped to puncture said sidewall are located, distal to the surface of said base, and generally perpendicular to the surface of said base, the resulting intersection of said planar surfaces creates a piercing area for enlarging said opening created by said piercing element, said piercing element and said piercing area are sufficiently sharp and durable to pierce said sidewall and enlarge the resulting hole to ventilate said container, and are in physical association with said can piercing means;
whereby said opener provides a means to create openings in the sidewall of containers with bead seams using said bead seam and said engagement means to create a fulcrum about which the container is pivoted.

4. The container opener of claim 3, wherein said planar body, said bead seam engagement means, and said container piercing means are formed of a plurality of materials suitable for said means to operate to open containers with bead seams;
whereby said container opener comprising a plurality of structures is readily assembled in few simple operations.

5. The container opener of claim 3, wherein said planar body is extended to form a lever body formed as a unitary elongated planar body of rigid material of sufficient size to be easily carried by a person, having a general upper surface and a general lower surface and said engagement puncturing means located at a distal end on the upper surface;
whereby said container opener provides a means to create openings in the sidewall of containers with bead seams using said bead seam and said engagement means to create a fulcrum about which the opener is pivoted to engage said piercing means.

6. The container opener of claim 5, wherein said lever body, said bead seam engagement means, and said container piercing means are formed of a plurality of materials suitable for said means to operate to open containers with bead seams;
whereby said container opener comprising a plurality of structures is readily assembled in few simple operations.

7. The container opener of claim 5, wherein said opener includes a device for removing the cap from capped bottles comprising:
a bottle cap edge gripping means located on said lower surface at the same distal end as said can ventilating means for gripping an edge of a bottle cap, said gripping means is formed in physical association with a fulcrum means and integrally with said lever body;
said gripping means is constructed of sufficiently durable material capable of retaining the ability to remove a multitude of bottle caps, formed generally as a rectangle formed of two intersecting planar surfaces ending in a gripping edge generally perpendicular to the axis of said lever body, and a predetermined angle to the surface of said planar body; and
said fulcrum is constructed of sufficiently strong material capable of not breaking during use removing a multitude of bottle caps, and is a predetermined distance from said gripping means;
whereby said beverage key provides a means to ventilate pop-top cans to allow a fluid to flow freely from the pouring opening of said pop-top can when being poured by allowing air to enter from a separate ventilation opening created on the sidewall of said pop-top can, said ventilation opening also provides a tactile indication of the location of said pouring opening, and said ventilation opening provides a means to differentiate similar looking pop-top cans from each other, remove the cap from capped bottles and lift the tab of said pop-top can.

8. The container opener of claim 7, wherein said lever body, said bead seam engagement means, and said can ventilation means are formed of a plurality of materials suitable for said means to operate to ventilate pop-top cans and create a means for tactile and visual differentiation and orientation, and remove the cap from capped bottles;
whereby said container opener comprising a plurality of structures is readily assembled in few simple operations.

9. The container opener of claim 7, wherein said opener includes a device for lifting the tab of said pop-top can comprising;
a pop-top can tab lifting means for fitting underneath a pop-top lift tab on a pop-top can, said lifting means formed as a portion at the distal end of said lever body;
said lifting means including a wedge surface means for fitting between said pop-top can lift tab and the top surface of said pop-top can;
whereby said beverage key provides a means to ventilate pop-top cans to allow a fluid to flow freely from the pouring opening of said pop-top can when being poured by allowing air to enter from a separate ventilation opening created on the sidewall of said pop-top can, said ventilation opening also provides a tactile indication of the location of said pouring opening, and said ventilation opening provides a means to differentiate similar looking pop-top cans from each other, remove the cap from capped bottles and lift the tab of said pop-top can.

10. The container opener of claim 9, wherein said lever body, said bead seam engagement means, and said can ventilation means are formed of a plurality of materials suitable for said means to operate to ventilate pop-top cans and create a means for tactile and visual differentiation and orientation, remove the cap from capped bottles and lift the tab of pop-top cans;
whereby said container opener comprising a plurality of structures is readily assembled in few simple operations.

11. A beverage key for ventilating a pop-top can, and creating tactile and visual indicium on said can, and removing the cap from capped bottles comprising:
a lever body formed as a unitary elongated planar body of rigid material of sufficient size to be easily carried by a person in a pocket, handbag or the like, and having a general upper surface and a general lower surface;
a combination engagement puncturing and gripping fulcrum means located on the upper surface at a distal end of said planar body is comprised of a combination container piercing and bottle cap fulcrum means and a combination bead seam engagement and bottle cap gripping means, said combination piercing fulcrum means and said combination engagement gripping means are in physical association and are formed as an extension of said planar body, and are separated by a predetermined distance to allow said combination engagement gripping means and combination piercing fulcrum means to engage and pierce said container sidewall, further said combination engagement gripping means and combination piercing fulcrum means are capable of removing the cap from capped bottles;
said combination engagement gripping means for engagement of a bead seam of a pop-top can is constructed of sufficiently durable material capable of retaining the ability to remove a multitude of bottle caps, being configured to engage a portion of said bead seam of said pop-top can creating a fulcrum or pivot such that when said container is pivoted about said fulcrum or pivot, the intersection of said combination piercing fulcrum means with said sidewall of said pop-top can in a manner that creates an opening in said sidewall; and
said combination piercing fulcrum means for piercing said sidewall, formed of material suitable for piercing the sidewall of said pop-top can and of sufficiently strong material capable of not breaking during use removing a multitude of bottle caps, is formed generally as a wedge comprising of two planar surfaces ending in a piercing element, wherein a point or a plurality of points sufficiently shaped to puncture said sidewall are located, distal to the axis of said lever body, and generally perpendicular to the surface of said planar body, the resulting intersection of said planar surfaces creates a piercing area for enlarging said opening created by said piercing element, said piercing element and said piercing area are sufficiently sharp and durable to pierce said sidewall and enlarge the resulting hole to ventilate said pop-top can, and are in physical association with said combination piercing fulcrum means;
whereby said beverage key provides a means to ventilate pop-top cans to allow a fluid to flow freely from the pouring opening of said pop-top can when being poured by allowing air to enter from a separate ventilation opening created on the sidewall of said pop-top can, said ventilation opening also provides a tactile indication of the location of said pouring opening, and said ventilation opening provides a means to differentiate similar looking pop-top cans from each other, and remove the cap from capped bottles.

12. The container opener of claim 11, wherein said planar body, said combination engagement gripping means, and said combination piercing fulcrum means are formed of a plurality of materials suitable for said means to operate to ventilate pop-top cans and create a means for tactile and visual differentiation and orientation, and remove the cap from capped;
whereby said container opener comprising a plurality of structures is readily assembled in few simple operations.

13. The container opener of claim 11, wherein said planar body is extended to form a lever body formed as a unitary elongated planar body of rigid material of sufficient size to be easily carried by a person, having a general upper surface and a general lower surface and said engagement puncturing means located at a distal end on the upper surface;
whereby said container opener provides a means to create openings in the sidewall of containers with bead seams using said bead seam and said combination engagement gripping means to create a fulcrum about which said lever body is pivoted to engage said combination piercing fulcrum means, and provide a means to remove caps from capped bottles using said combination engagement gripping means to grip the edge of said cap and pivoting said lever body around said combination piercing fulcrum.

14. The container opener of claim 13, wherein said lever body, said combination engagement gripping means, and said combination piercing fulcrum means are formed of a plurality of materials suitable for said means to operate to ventilate pop-top cans and create a means for tactile and visual differentiation and orientation, remove the cap from capped bottles and lift the tab of pop-top cans;
whereby said container opener comprising a plurality of structures is readily assembled in few simple operations.

15. The container opener of claim 13, wherein said lever body is extended to form a the tab lift means distal to said combination engagement puncturing and gripping fulcrum means;
whereby said lift body may be used to lift the tab of a pop-top can for opening.

16. The beverage key of claim 15, wherein said planar body, said combination engagement gripping means, said tab lift means, and said combination piercing fulcrum means are formed of a plurality of materials suitable for said means to operate to ventilate pop-top cans and create a means for tactile and visual differentiation and orientation, and remove the cap from capped;
whereby said container opener comprising a plurality of structures is readily assembled in few simple operations.
